(19) United States
(12) Patent Application Publication
(10) Pub. No.: US 2007/0067764 A1
(43) Pub. Date: Mar. 22, 2007

(54) System and method for automated interpretation of console field changes

(76) Inventors: Brandy S. Byrd, Cary, NC (US); Jana H. Jenkins, Raleigh, NC (US); Marva L. Richey, Raleigh, NC (US); Carrie L. Stappenbacher, Morrisville, NC (US)

Correspondence Address: DILLON & YUDELL LLP, 8911 N. CAPITAL OF TEXAS HWY., SUITE 2110, AUSTIN, TX, 78759, US

(21) Appl. No.: 11/232,831

(22) Filed: Sep. 22, 2005

(51) Int. Cl. G06F 9/44; G06F 17/30

(52) U.S. Cl. 717/168; 707/1

(57) ABSTRACT

A method, apparatus, and computer-usable medium for assembling a database that associates a collection of user interface panels with at least one user. At least one preference for periodically monitoring said plurality of user interface panels for changes is set and written to memory. A collection of documentation files associated with the collection of user interface panels is created and written to memory. In response to detecting at least one change in the collection of user interface panels, a notification is automatically sent to the at least one user. The notification includes specifying the at least one change and at least one documentation file among the collection of documentation files affected by the at least one change.

### BACKGROUND OF THE INVENTION

The present invention relates in general to the field of computers and similar technologies, and in particular to software utilized in this field.

Early computers were stand-alone units, which accessed and processed only local databases using local computer programs. Today, however, modern computers are often networked, thus providing client computers on a network access to a variety of resources, including data, computer programs, hardware devices (including storage drives and printers), etc. This resource availability is especially prevalent with the advent of the Internet, World Wide Web, private intranets and extranets, etc., which provide access to web pages, databases, programs, and similar resources. Development of software for modern computers, once a task performed by a single programmer or a small group of programmers, is now performed by teams of developers and associated technical writers that document the software.

Generally, when a software package is developed, technical writers are required to document the function of each aspect of the software, which usually include user interface panels. For example, many modern word processing programs include a font user interface panel that enables a user to change the type of font displayed and the options related to the appearance of the selected font. Once a user has selected a preferred font (e.g., Times New Roman or Courier New), the user may change options related to the appearance of the font, such as the font size (e.g., 8, 10, 12, or larger font size), color, or whether the font would be display with bold, italicized, or underlined features.

During the development of the word processing program, a technical writer may be responsible for documenting the function of the font user interface panel. During software development, aspects of the font user interface panel may be changed. For example, the location of a font selection toolbar may be altered or deleted. The technical writer assigned to document the function of the font user interface panel would need to update the written documentation associated with the font user interface panel to reflect the changes made.

### SUMMARY OF THE INVENTION

Recognizing a need to address the above described need in the prior art, the present invention includes, but is not limited to, a method, apparatus, and computer-usable medium for assembling a database that associates a collection of user interface panels with at least one user. Preferences for periodically monitoring the collection of user interface panels for changes are set and written to memory. A collection of documentation files associated with the collection of user interface panels is created and written to memory. In response to detecting a change in the collection of user interface panels, a notification is automatically sent to the user. The notification includes specifying the change and the documentation file among the collection of documentation files affected by the change.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 illustrates an exemplary data processing system in which a preferred embodiment of the present invention may be implemented;

FIG. 2A depicts an exemplary network in which a preferred embodiment of the present invention may be implemented;

FIG. 2B illustrates the contents of system memory 104 of clients 206a-n according to a preferred embodiment of the present invention;

FIG. 2C depicts the contents of system memory 104 of server 202 according to a preferred embodiment of the present invention;

FIG. 3 is a high-level logical flowchart diagram of an exemplary method of automated interpretation of console field changes according to a preferred embodiment of the present invention;

FIGS. 4A-B show a flowchart of steps taken to deploy software capable of executing the steps shown and described in FIG. 3.

FIGS. 5A-C show a flowchart of steps taken to deploy in a Virtual Private Network (VPN) software that is capable of executing the steps shown and described in FIG. 3.

FIGS. 6A-C show a flowchart showing steps taken to integrate into a computer system software that is capable of executing the steps shown and described in FIG. 3; and

FIGS. 7A-B show a flowchart showing steps taken to execute the steps shown and described in FIG. 3 using an on-demand service provider.

### DETAILED DESCRIPTION OF THE PREFERRED EMBODIMENT

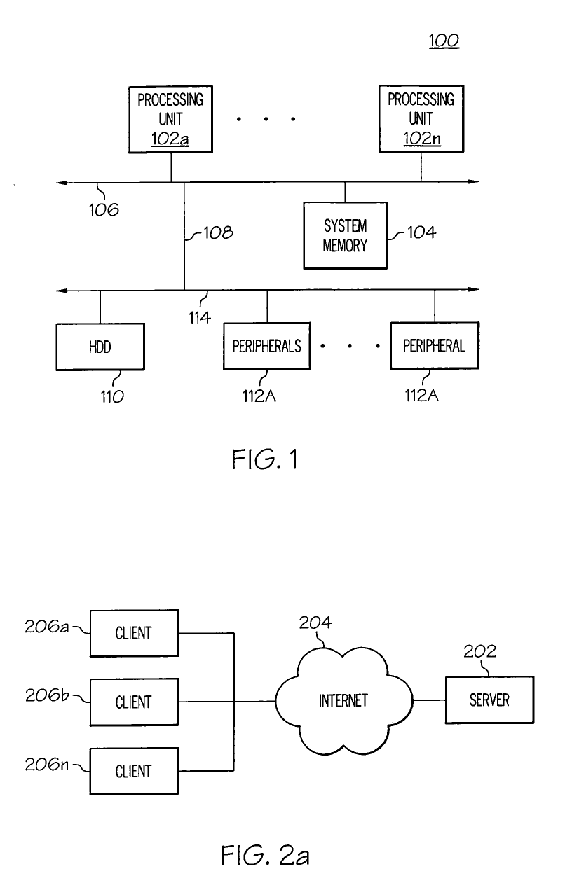

With reference now to the figures, and in particular to FIG. 1, there is depicted a block diagram of an exemplary data processing system in which a preferred embodiment of the present invention may be implemented. As depicted, exemplary data processing system 100 includes processing unit(s) 102, shown as processing units 102a and 102b in FIG. 1, which are coupled to system memory 104 via system bus 106. Preferably, system memory 104 may be implemented as a collection of dynamic random access memory (DRAM) modules. Typically, system memory 104 includes data and instructions for running a collection of applications. Mezzanine bus 108 acts as an intermediary between system bus 106 and peripheral bus 114. Those with skill in this art will appreciate that peripheral bus 114 may be implemented as a peripheral component interconnect (PCI), accelerated graphics port (AGP), or any other peripheral bus. Coupled to peripheral bus 114 is hard disk drive 110, which is utilized by data processing system 100 as a mass storage device. Also coupled to peripheral bus 114 is a collection of peripherals 112a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 to improve handling of shared resources provided by the present invention are applicable to data processing systems of any system architecture and are in no way limited to the generalized multi-processor architecture or symmetric multi-processing (SMP) architecture illustrated in FIG. 1.

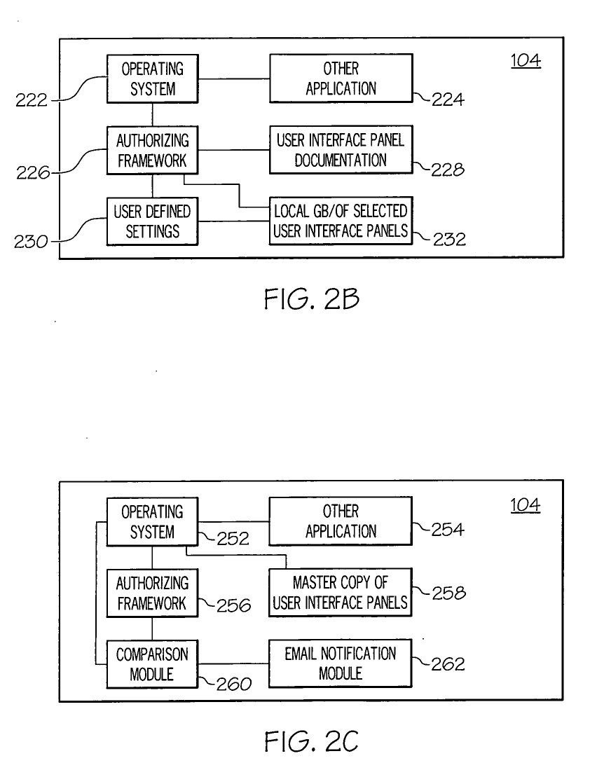

FIG. 2A is a block diagram depicting an exemplary computer network 200 in which a preferred embodiment of the present invention may be implemented. As illustrated, network 200 couples server 202, Internet 204, and a collection of clients 206a-n. Server 202 and clients 206a-n may be implemented by data processing systems such as data processing system 100 of FIG. 1. Those with skill in this art will appreciate that while FIG. 2A illustrates Internet 204 coupling server 202 and clients 206a-n, network 200 may be implemented by any type of interconnect, including but not limited to, Ethernet, 802.11x, etc.

FIG. 2B is a block diagram illustrating the contents of system memory 104 of clients 206a-n according to a preferred embodiment of the present invention. As depicted, system memory of clients 206a-n includes operating system 222, other applications 224, authoring framework 226, user interface panel documentation 228, user defined settings 230, and a local copy of selected user interface panels 232. As well-known by those with skill in the art, operating system 222 is system software responsible for the control and management of hardware and basic system operations. Operating system 222 also provides a foundation on which to run application software including, but not limited to, word processors, web browsers, authoring framework 226, and other applications 224.

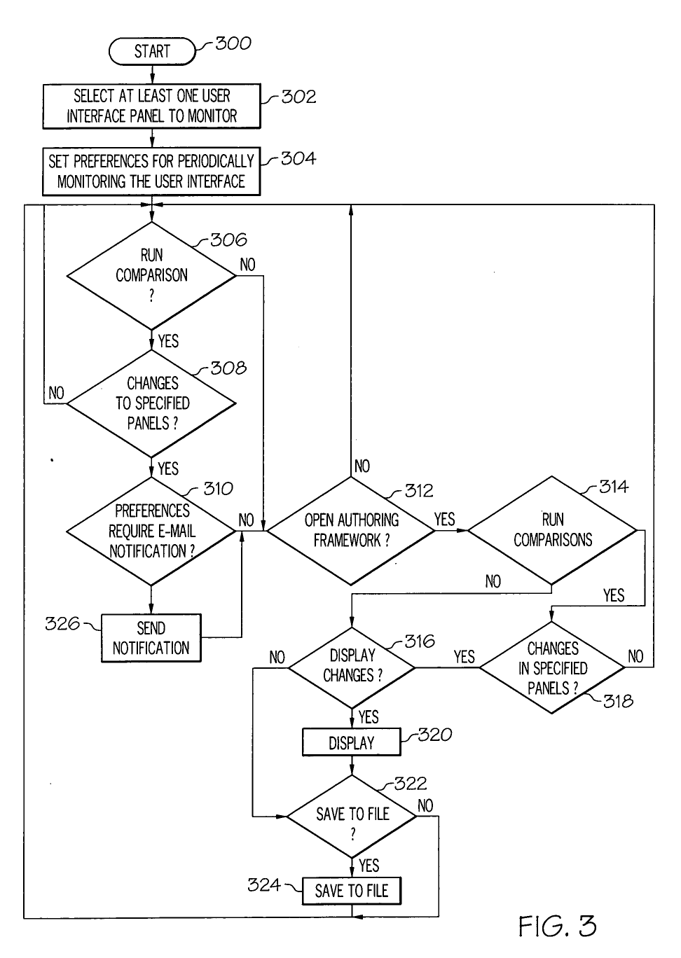

Authoring framework 226, described herein in more detail in conjunction with FIG. 3, is utilized by a technical writer to generate user interface panel documentation 228 that describes the function of user interface panels in a software package. User defined settings 230 indicate a variety of options including, but not limited to, the actual user interface panels that are monitored, the period in which the monitoring takes place, and whether or not the technical writer wants to be notified of the changes in the selected user interface panels via e-mail. In a preferred embodiment of the present invention, system memory 104 of clients 206a-n includes a local copy of the user interface panels selected by the technical writer. This local copy 232 is compared with a master copy 258 (FIG. 2C) during the comparison as described herein in more detail in conjunction with FIG. 3.

FIG. 2C is a block diagram illustrating contents of system memory 104 of server 202 according to a preferred embodiment of the present invention. As depicted, system memory 104 of server 202 includes operating system 252, other applications 254, database of user/panel associations 256, master copy of user interface panels 258, comparison modules 260, and e-mail notification module 262. Operating system 252 is system software responsible for the control and management of hardware and basic system operations. Operating system 252 also provides a foundation on which to run application software including, but not limited to, word processors, web browsers, other applications 254, comparison module 260, and e-mail notification module 262, all described herein in more detail in conjunction with FIG. 3.

FIG. 3 is a high-level flowchart diagram illustrating an exemplary method of automated notification of user interface panel changes according to a preferred embodiment of the present invention.

As depicted, the process begins at step 300 and proceeds to an initialization process (steps 302 and 304). By initializing user-defined settings 230 stored in system memory 104 of one of clients 206a-n, clients 206a-n indicate the specific user interface panels that they would like to monitor (step 302) and settings related to the monitoring of the panels (step 304). In a preferred embodiment of the present invention, user-defined settings 230 include, but are not limited to, the duration of the monitoring, the frequency of the monitoring, and the preferred method of notification (e.g., via e-mail, etc.). Once user defined settings 230 are determined, a comparison of two copies of the user interface panels (local copy 232 and master copy 258) is performed in accordance with the settings 230 (step 306). For example, user-defined settings 230 may indicate that the monitoring (i.e., comparison) of the selected panels be performed hourly, for a period of two weeks, with notification of any changes to be sent to the associated technical writer by e-mail.

As previously discussed, a local copy of selected user interface panels 232 is stored in system memory 104 of clients 206a-n for comparison purposes. Local copy 232, from the view of clients 206a-n, incorporates the most recent changes from the last comparison with master copy 258, stored in system memory 104 of server 202. When a comparison is run by comparison module 260, local copy 232 is compared with master copy 258 and all differences are cataloged, the technical writer responsible for the selected user interface panels is notified of the changes, and local copy 232 is updated, incorporating the noted differences.

If a comparison between local copy 232 and master copy 258 is performed by comparison module 260, and there are no changes to the specified panels (step 308), the process returns to step 306 and continues in an iterative fashion. If the comparison reveals that there are changes to the specified user interface panels, the process continues to step 310, which illustrates e-mail notification module 262 determining whether to send an e-mail notification to the technical writer associated with the specified user interface panels. If user-defined settings 230 indicate that the technical writer requests e-mail notification of the changes, the process continues to step 326, which illustrates e-mail notification module 230 sending the e-mail notification via Internet 204. The process then proceeds to step 312.

Steps 312-324 describe a comparison and notification loop if client 206a decides to open authoring framework 226 (step 312). If client 206a does not decide to open authoring framework 226, the process returns to step 306 and proceeds in an iterative fashion. If client 206a opens authoring framework 226, the process continues to step 314.

Step 314 illustrates client 206a determining whether to request a comparison of local copy 232 with master copy 258. If a comparison is requested by client 206a, comparison module 260 performs a comparison of local copy 232 with master copy 258. If there are no differences (i.e., changes) between local copy 232 and master copy 258 (step 318), the process returns to step 306 and proceeds in an iterative fashion. If there are differences between local copy 232 and master copy 258, the process proceeds to step 316. Returning to step 314, if a comparison is not requested by client 206a, the process continues to step 316.

Step 316 illustrates client 206a determining whether to display the changes between local copy 232 and master copy 258. If client 206a decides to display the changes, the process proceeds to step 320, which depicts the display of the changes to the technical writer, and continues to step 322. If client 206a decides not to display the changes, the process continues to step 322, which illustrates client 206a prompting the technical writer to determine whether to save the changes to a file for future reference. If the changes are not saved, the process returns to step 306. If client 206a decides to save the changes, the process proceeds to step 324, which depict the changes beings saved to a file. The process then returns to step 306 and proceeds in an iterative fashion.

As disclosed, the present invention includes, but is not limited to, a method, apparatus, and computer-usable medium for assembling a database that associates a collection of user interface panels with at least one user. At least one preference for periodically monitoring said plurality of user interface panels for changes is set and written to memory. A collection of documentation files associated with the collection of user interface panels is created and written to memory. In response to detecting at least one change in the collection of user interface panels, a notification is automatically sent to the at least one user. The notification includes specifying the at least one change and at least one documentation file among the collection of documentation files affected by the at least one change. Those with skill in the art will appreciate that while a preferred embodiment of the present invention is disclosed as a system and method for automated notification of console field changes between technical writers and software developers, the present invention includes any implementation of automated notification of changes within any type of file and specifying the effects of the changes to an another associated file.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet, the Internet, wireless networks, and like network systems. It should be understood, therefore, in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Software Deployment

Thus, the method described herein, and in particular as shown and described in FIG. 3, can be deployed as a process software from service provider server 202 to client computer(s) 206a-n.

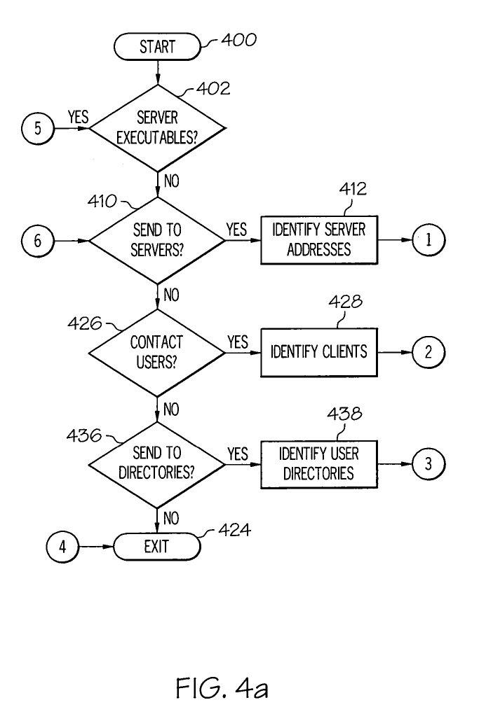

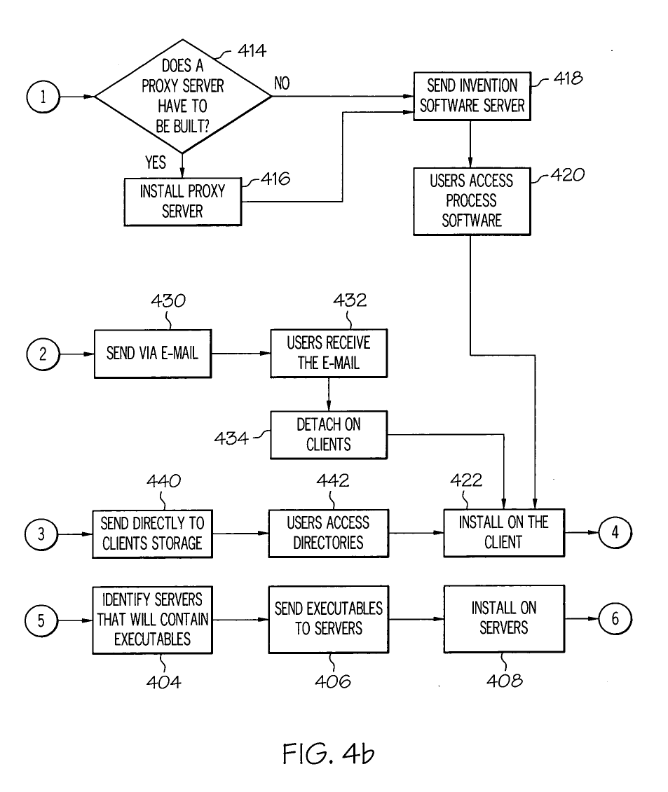

Referring then to FIG. 4, step 400 begins the deployment of the process software. The first thing is to determine if there are any programs that will reside on a server or servers when the process software is executed (query block 402). If this is the case, then the servers that will contain the executables are identified (block 404). The process software for the server or servers is transferred directly to the servers' storage via File Transfer Protocol (FTP) or some other protocol or by copying though the use of a shared file system (block 406). The process software is then installed on the servers (block 408).

Next, a determination is made on whether the process software is be deployed by having users access the process software on a server or servers (query block 410). If the users are to access the process software on servers, then the server addresses that will store the process software are identified (block 412).

A determination is made if a proxy server is to be built (query block 414) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 416). The process software is sent to the servers either via a protocol such as FTP or it is copied directly from the source files to the server files via file sharing (block 418). Another embodiment would be to send a transaction to the servers that contained the process software and have the server process the transaction, then receive and copy the process software to the server's file system. Once the process software is stored at the servers, the users via their client computers, then access the process software on the servers and copy to their client computers file systems (block 420). Another embodiment is to have the servers automatically copy the process software to each client and then run the installation program for the process software at each client computer. The user executes the program that installs the process software on his client computer (block 422) then exits the process (terminator block 424).

In query step 426, a determination is made whether the process software is to be deployed by sending the process software to users via e-mail. The set of users where the process software will be deployed are identified together with the addresses of the user client computers (block 428). The process software is sent via e-mail to each of the users' client computers (block 430). The users then receive the e-mail (block 432) and then detach the process software from the e-mail to a directory on their client computers (block 434). The user executes the program that installs the process software on his client computer (block 422) then exits the process (terminator block 424).

Lastly a determination is made on whether the process software will be sent directly to user directories on their client computers (query block 436). If so, the user directories are identified (block 438). The process software is transferred directly to the user's client computer directory (block 440). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 442). The user executes the program that installs the process software on his client computer (block 422) and then exits the process (terminator block 424).

VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a companies multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

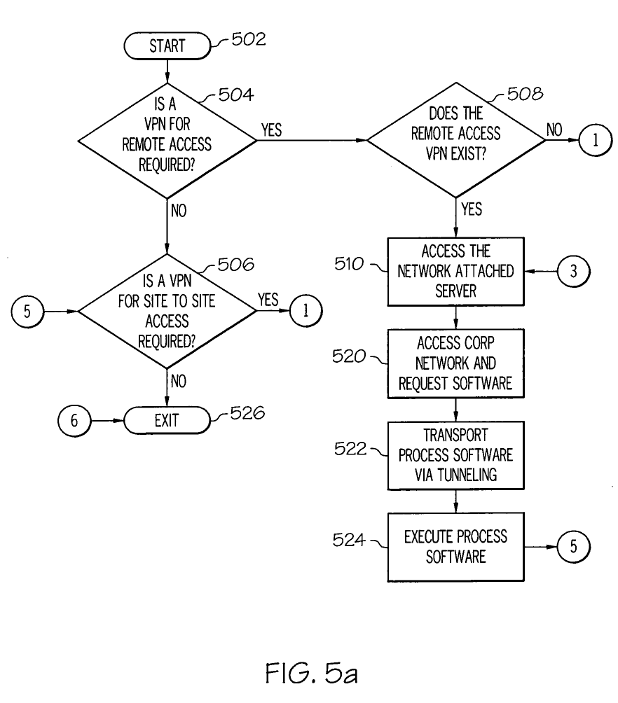

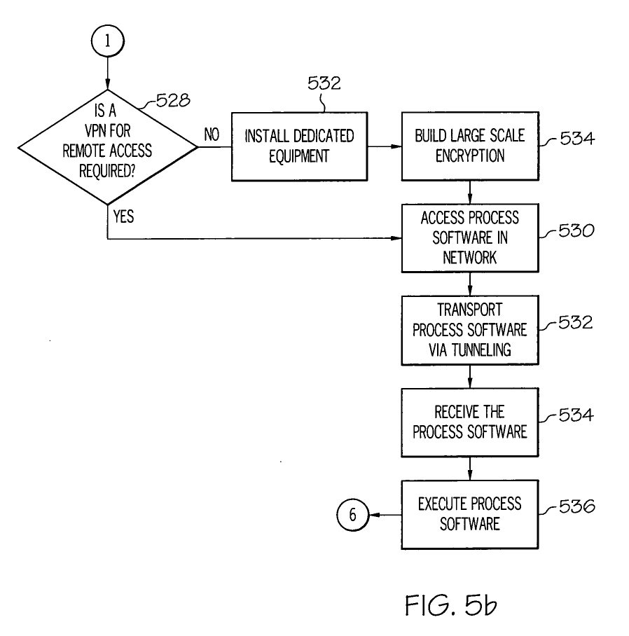

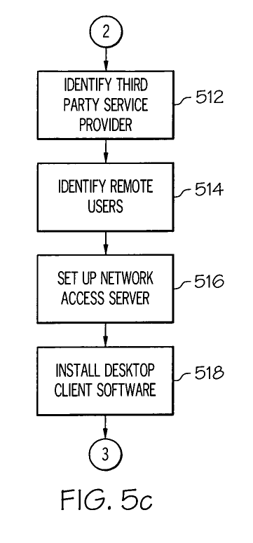

The process for such VPN deployment is described in FIG. 5. Initiator block 502 begins the Virtual Private Network (VPN) process. A determination is made to see if a VPN for remote access is required (query block 504). If it is not required, then proceed to (query block 506). If it is required, then determine if the remote access VPN exists (query block 508).

If a VPN does exist, then proceed to block 510. Otherwise identify a third party provider that will provide the secure, encrypted connections between the company's private network and the company's remote users (block 512). The company's remote users are identified (block 514). The third party provider then sets up a network access server (NAS) (block 516) that allows the remote users to dial a toll free number or attach directly via a broadband modem to access, download and install the desktop client software for the remote-access VPN (block 518).

After the remote access VPN has been built or if it has been previously installed, the remote users can access the process software by dialing into the NAS or attaching directly via a cable or DSL modem into the NAS (block 510). This allows entry into the corporate network where the process software is accessed (block 520). The process software is transported to the remote user's desktop over the network via tunneling. That is the process where software is divided into packets and each packet including the data and protocol is placed within another packet (block 522). When the process software arrives at the remote user's desk-top, it is removed from the packets, reconstituted and then is executed on the remote users desk-top (block 524).

A determination is then made to see if a VPN for site to site access is required (query block 506). If it is not required, then proceed to exit the process (terminator block 526). Otherwise, determine if the site to site VPN exists (query block 528). If it does exist, then proceed to block 530. Otherwise, install the dedicated equipment required to establish a site to site VPN (block 532). Then build the large scale encryption into the VPN (block 534).

After the site to site VPN has been built or if it had been previously established, the users access the process software via the VPN (block 530). The process software is transported to the site users over the network via tunneling (block 532). That is the process software is divided into packets and each packet including the data and protocol is placed within another packet (block 534). When the process software arrives at the remote user's desktop, it is removed from the packets, reconstituted and is executed on the site users desk-top (block 536). The process then ends at terminator block 526.

Software Integration

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

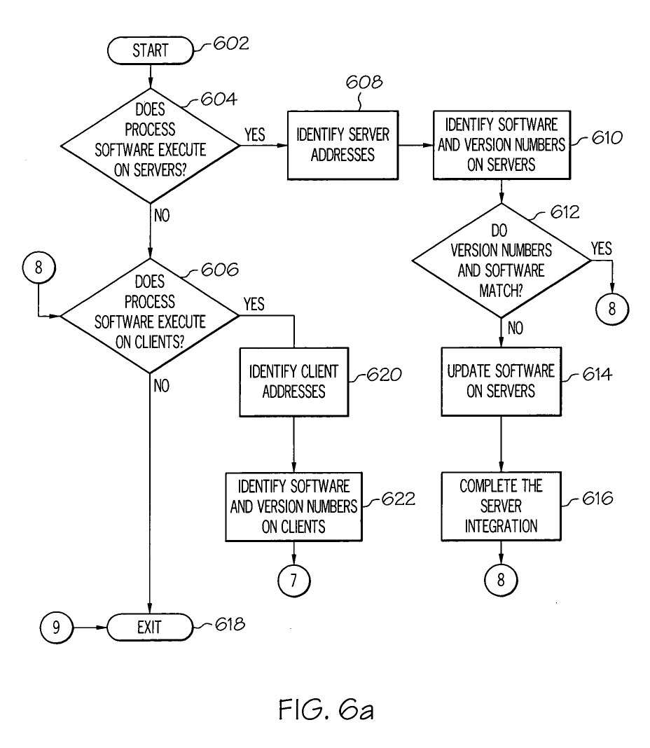

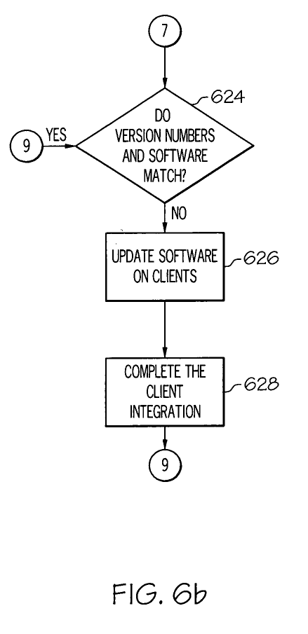

For a high-level description of this process, reference is now made to FIG. 6. Initiator block 602 begins the integration of the process software. The first tiling is to determine if there are any process software programs that will execute on a server or servers (block 604). If this is not the case, then integration proceeds to query block 606. If this is the case, then the server addresses are identified (block 608). The servers are checked to see if they contain software that includes the operating system (OS), applications, and network operating systems (NOS), together with their version numbers, which have been tested with the process software (block 610). The servers are also checked to determine if there is any missing software that is required by the process software in block 610.

A determination is made if the version numbers match the version numbers of OS, applications and NOS that have been tested with the process software (block 612). If all of the versions match and there is no missing required software the integration continues in query block 606.

If one or more of the version numbers do not match, then the unmatched versions are updated on the server or servers with the correct versions (block 614). Additionally, if there is missing required software, then it is updated on the server or servers in the step shown in block 614. The server integration is completed by installing the process software (block 616).

The step shown in query block 606, which follows either the steps shown in block 604, 612 or 616 determines if there are any programs of the process software that will execute on the clients. If no process software programs execute on the clients the integration proceeds to terminator block 618 and exits. If this is not the case, then the client addresses are identified as shown in block 620.

The clients are checked to see if they contain software that includes the operating system (OS), applications, and network operating systems (NOS), together with their version numbers, which have been tested with the process software (block 622). The clients are also checked to determine if there is any missing software that is required by the process software in the step described by block 622.

A determination is made is if the version numbers match the version numbers of OS, applications and NOS that have been tested with the process software (query block 624). If all of the versions match and there is no missing required software, then the integration proceeds to terminator block 618 and exits.

If one or more of the version numbers do not match, then the unmatched versions are updated on the clients with the correct versions (block 626). In addition, if there is missing required software then it is updated on the clients (also block 626). The client integration is completed by installing the process software on the clients (block 628). The integration proceeds to terminator block 618 and exits.

On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

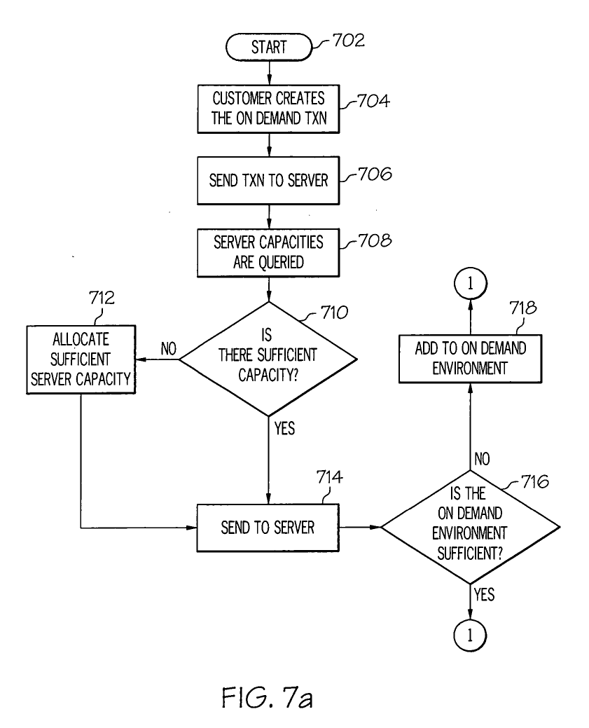

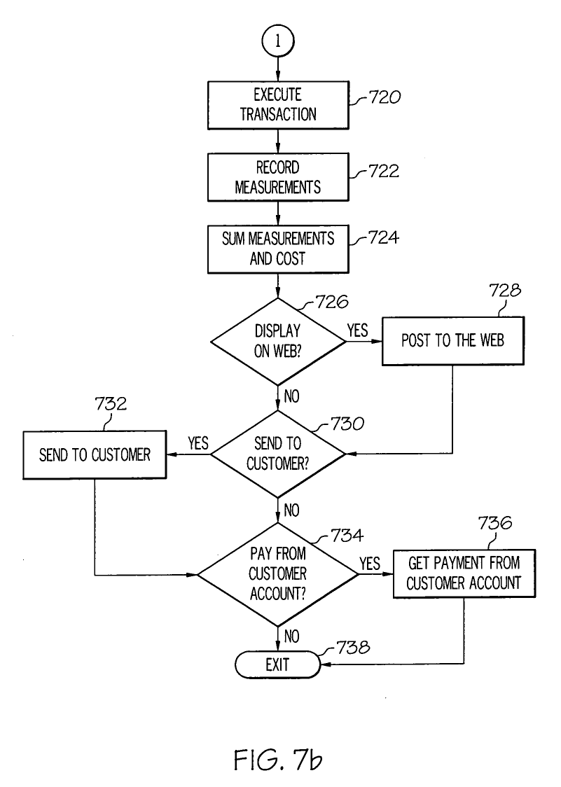

With reference now to FIG. 7, initiator block 702 begins the On Demand process. A transaction is created than contains the unique customer identification, the requested service type and any service parameters that further, specify the type of service (block 704). The transaction is then sent to the main server (block 706). In an On Demand environment the main server can initially be the only server, then as capacity is consumed other servers are added to the On Demand environment.

The server central processing unit-(CPU) capacities in the On Demand environment are queried (block 708). The CPU requirement of the transaction is estimated, then the servers available CPU capacity in the On Demand environment are compared to the transaction CPU requirement to see if there is sufficient CPU available capacity in any server to process the transaction (query block 710). If there is not sufficient server CPU available capacity, then additional server CPU capacity is allocated to process the transaction (block 712). If there was already sufficient available CPU capacity then the transaction is sent to a selected server (block 714).

Before executing the transaction, a check is made of the remaining On Demand environment to determine if the environment has sufficient available capacity for processing the transaction. This environment capacity consists of such things as but not limited to network bandwidth, processor memory, storage etc. (block 716). If there is not sufficient available capacity, then capacity will be added to the On Demand environment (block 718). Next the required software to process the transaction is accessed, loaded into memory, then the transaction is executed (block 720).

The usage measurements are recorded (block 722). The usage measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 724).

If the customer has requested that the On Demand costs be posted to a web site (query block 726), then they are posted (block 728). If the customer has requested that the On Demand costs be sent via e-mail to a customer address (query block 730), then these costs are sent to the customer (block 732). If the customer has requested that the On Demand costs be paid directly from a customer account (query block 734), then payment is received directly from the customer account (block 736). The On Demand process is then exited at terminator block 738.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method comprising:
assembling a database that associates a plurality of user interface panels with at least one user;
setting at least one preference for periodically monitoring said plurality of user interface panels for changes;
creating a plurality of documentation files associated with said plurality of user interface panels; and
in response to detecting at least one change in said plurality of user interface panels, automatically sending a notification to said at least one user, wherein said notification includes specifying said at least one change and at least one documentation file among said plurality of documentation files affected by said at least one change.

2. The computer-implementable method according to claim 1, further comprising:
in response to said at least one user utilizing an authoring framework to open at least one documentation file among said plurality of documentation files, specifying at least one change in said plurality of user interface panels associated with said at least one documentation file.

3. The computer-implementable method according to claim 1, wherein said automatically sending a notification further comprises:
automatically sending a notification to said at least one user via an e-mail message.

4. The computer-implementable method according to claim 1, wherein said detecting at least one change in said plurality of user interface panels further comprises:
comparing a local copy of said plurality of user interface panels with a master copy of said plurality of user interface panels.

5. The computer-implementable method according to claim 1, further comprising:
saving said at least one change in said plurality of user interface panels to a file.

6. A system comprising:
a processor;
a data bus coupled to the processor;
a memory coupled to the data bus; and
a computer-usable medium embodying computer program code, the computer program code comprising instructions executable by the processor and configured to:
assemble a database that associates a plurality of user interface panels with at least one user;
set at least one preference for periodically monitoring said plurality of user interface panels for changes;
create a plurality of documentation files associated with said plurality of user interface panels; and
in response to detecting at least one change in said plurality of user interface panels, automatically send a notification to said at least one user,
wherein said notification includes specifying said at least one change and at least one documentation file among said plurality of documentation files affected by said at least one change.

7. The system according to claim 6, wherein the instructions are further configured to:
in response to said at least one user utilizing an authoring framework to open at least one documentation file among said plurality of documentation files, specify at least one change in said plurality of user interface panels associated with said at least one documentation file.

8. The system according to claim 6, wherein said instructions configured to automatically send a notification further comprises instructions configured to:
automatically send a notification to said at least one user via an e-mail message.

9. The system according to claim 6, wherein said instructions configured to detect at least one change in said plurality of user interface panels further comprises instructions configured to:
compare a local copy of said plurality of user interface panels with a master copy of said plurality of user interface panels.

10. The system according to claim 6, wherein the instructions are further configured to:
compare a local copy of said plurality of user interface panels with a master copy of said plurality of user interface panels.

11. A computer-usable medium embodying computer program code, the computer program code comprising computer executable instructions configured to:
assemble a database that associates a plurality of user interface panels with at least one user;
set at least one preference for periodically monitoring said plurality of user interface panels for changes;
create a plurality of documentation files associated with said plurality of user interface panels; and
in response to detecting at least one change in said plurality of user interface panels, automatically send a notification to said at least one user, wherein said notification includes specifying said at least one change and at least one documentation file among said plurality of documentation files affected by said at least one change.

12. The computer-usable medium of claim 11, wherein the embodied computer program code further comprises computer executable instructions configured to:
in response to said at least one user utilizing an authoring framework to open at least one documentation file among said plurality of documentation files, specify at least one change in said plurality of user interface panels associated with said at least one documentation file.

13. The computer-usable medium of claim 11, wherein said computer executable instructions configured to automatically send a notification further comprise computer executable instructions configured to:
automatically send a notification to said at least one user via an e-mail message.

14. The computer-usable medium of claim 11, wherein said computer executable instructions configured to detect at least one change in said plurality of user interface panels further comprise computer executable instructions configured to:
compare a local copy of said plurality of user interface panels with a master copy of said plurality of user interface panels.

15. The computer-usable medium of claim 11, wherein said computer executable instructions further comprise computer executable instructions configured to:
saving said at least one change in said plurality of user interface panels to a file.

16. The computer-useable medium of claim 11, wherein the computer executable instructions are deployable to a client computer from a server at a remote location.

17. The computer-useable medium of claim 11, wherein the computer executable instructions are provided by a service provider to a customer on an on-demand basis.
